(19) United States
(12) Patent Application Publication
(10) Pub. No.: US 2025/0032926 A1
(43) Pub. Date: Jan. 30, 2025

(54) METHOD AND SYSTEM FOR MIXED-REALITY RACE GAME

(71) Applicant: Sunburn Capital L.L.C-FZ, Dubai (AE)

(72) Inventors: Mikko Spoof, Dubai (AE); Lauri Koutaniemi, Dubai (AE)

(21) Appl. No.: 18/823,043

(22) Filed: Sep. 3, 2024

Related U.S. Application Data
(63) Continuation of application No. PCT/IB2024/057236, filed on Jul. 26, 2024.

(30) Foreign Application Priority Data
Jul. 26, 2023 (FI) 20235839

(51) Int. Cl. A63F 13/65; A63F 13/803

(52) U.S. Cl. CPC A63F 13/65; A63F 13/803

(57) ABSTRACT

The present invention relates to a method and system for mixed-reality race game. The method comprises receiving telemetry data from the real-world racer moving on the real-world racetrack, and associating telemetry data of the real-world racer with the virtual racer model and receiving control data from a user device, and associating the control data with the controllable virtual racer. The method further comprises calculating position and speed of the virtual racer model in a virtual racetrack based on the telemetry data associated with the virtual racer model, and calculating position and speed of the controllable virtual racer in the virtual racetrack based on the control data associated with the controllable virtual racer.

### CROSS-REFERENCE TO RELATED APPLICATIONS/CLAIM TO PRIORITY

This application claims priority to PCT Application Number PCT/IB2024/057236 filed on 26 Jul. 2024, which claims priority to Finnish Application FI-20235839 filed on 26 Jul. 2023, each of which is herein incorporated by reference in its entirety.

### FIELD OF THE INVENTION

The present invention relates to a method for mixed-reality race game and more particularly to a method according to preamble of claim 1. The present invention further relates to a system for mixed-reality race game and more particularly to a system according to preamble of claim 21.

### BACKGROUND OF THE INVENTION

In the prior art race games played with computer system users playing the game are configured to play against other players in a multiplayer game. The disadvantage of the prior art is that the race games need multiple players at the same time in order to play the game against other human players. A further disadvantage is that the prior art games lack realistic racing experiments.

### BRIEF DESCRIPTION OF THE INVENTION

An object of the present invention is to provide a method and system for mixed-reality race game so as to solve or at least alleviate the prior art disadvantages.

The objects of the invention are achieved by a method for mixed reality race game which is characterized by what is stated in the independent claim 1. The objects of the invention are also achieved by a system for mixed reality race game which is characterized by what is stated in the independent claim 21.

The preferred embodiments of the invention are disclosed in the dependent claims.

The invention is based on the idea of providing a method for mixed-reality race game. The method is carried out by a computer system in a network having at least one user device. The method is carried out by the computer system and comprises:
a) providing a virtual racing environment comprising a virtual racetrack, the virtual racetrack being a virtual representation of a real-world racetrack,
b) providing a virtual racer model representing a real-world racer,
c) providing a controllable virtual racer,
d) receiving, in the computer system, telemetry data from the real-world racer moving on the real-world racetrack, the telemetry data comprising at least position data and motion data of the real-world racer, and associating telemetry data of the real-world racer with the virtual racer model,
e) receiving, in the computer system, control data from a user device, and associating the control data with the controllable virtual racer,
f) calculating position and speed of the virtual racer model in the virtual racetrack based on the telemetry data associated with the virtual racer model,
g) calculating position and speed of the controllable virtual racer in the virtual racetrack based on the control data associated with the controllable virtual racer, and
h) generating a visual representation of the mixed-reality race game comprising the virtual racing environment representing the virtual racer model together with the controllable virtual racer in the virtual racetrack based on the calculated position and speed of the virtual racer model and the calculated position and speed of the controllable virtual racer.

The method further comprises:
i) receiving, in the computer system, environmental measurement data from one or more environmental sensors provided in connection with the real-world racetrack, and
j) modifying the control data associated with the controllable virtual racer based on the environmental measurement data and generating modified control data based on modifying the control data, and
   the step g) comprises calculating position and speed of the controllable virtual racer in the virtual racetrack based on the modified control data associated with the controllable virtual racer.

The method enables providing a mixed-reality race game in which the human user is able to play against real-world racers of a real-world race. Accordingly, the present invention provides a multiplayer race game in which the user operating the controllable virtual racer is playing against real-world racers. Thus, the user operating the controllable virtual racer is able to take part in the real-world race in the virtual environment by operating the controllable virtual racer among virtualized real-world racers. Further, modifying the control data based on the environmental measurements from the sensor(s) provided in connection with the real-world race enables the virtual racer to move in more realistic manner taking into account the environmental characteristics in the real-world racetrack.

In some embodiments, the step i) comprises calculating racetrack data by utilizing the environmental measurement data, and determining virtual racetrack characteristics of the virtual racetrack based on the calculated racetrack data, and the step j) comprises modifying the control data associated with the controllable virtual racer based on the determined virtual racetrack characteristics and generating the modified control data based on the determined virtual racetrack characteristics.

Accordingly, racetrack characteristics are taken into account for modifying the control data.

In some embodiments, the step i) comprises calculating racetrack data by utilizing the environmental measurement data, and determining virtual racing environment characteristics of the virtual racing environment based on the calculated racetrack data, and the step j) comprises modifying the control data associated with the controllable virtual racer based on the determined virtual racing environment characteristics and generating the modified control data based on the determined virtual racing environment characteristics or based on the determined virtual racetrack characteristics and the determined virtual racing environment characteristics.

Accordingly, environmental characteristics or environmental characteristics and racetrack characteristics are considered for modifying the control data.

In some embodiments, in the step e) the control data comprises at least motion control data, the motion control data defining motion of the controllable virtual racer in the virtual racing environment, the step j) comprises generating modified motion control data, and the step g) comprises calculating position and speed or position, speed and orientation of the controllable virtual racer in the virtual racetrack based on the modified motion control data.

Accordingly, the environmental measurement data is utilized for modifying the motion control data of the virtual racer. The motion control data comprises at least position and speed or position, speed and orientation of the controllable virtual racer.

In some embodiments, in the step e) the control data comprises orientation control data, the orientation control data defining orientation of the controllable virtual racer in the virtual racing environment, the step j) comprises generating modified orientation control data, and the step g) comprises calculating orientation of the controllable virtual racer in the virtual racetrack based on the modified orientation control data.

Accordingly, the environmental measurement data is utilized for modifying the orientation control data of the virtual racer. The orientation control data is configured to determine orientation of the virtual racer in the virtual racing environment.

In some embodiments, the step i) comprises receiving, in the computer system, the environmental measurement data as real-time environmental measurement data, the step e) comprises receiving, in the computer system, the control data as real-time control data, the step j) comprises generating continuously real-time modified control data based on modifying the real-time control data, and the step g) comprises calculating continuously real-time position and speed of the controllable virtual racer in the virtual racetrack based on the real-time modified control data.

This allows providing at least the position and speed of the virtual racer in in the virtual race track in real-time based on the modified control data.

In some other embodiments, the step j) comprises generating continuously instantaneous modified control data based on modifying the received control data, and the step g) comprises calculating continuously instantaneous position and speed of the controllable virtual racer in the virtual racetrack based on the instantaneous modified control data.

This allows providing at least the instantaneous position and speed of the virtual racer in in the virtual race track based on the modified control data.

In some embodiments, the method comprises in the step h) of generating the visual representation of the virtual racing environment by utilizing the environmental measurement data.

Ins some other embodiments, the method comprises in the step h) of generating the visual representation of the virtual racing environment by utilizing the calculated racetrack data, the virtual racing environment comprising visual representation of the determined virtual racing environment characteristics of the virtual racing environment, visual representation of the determined virtual racetrack characteristics of the virtual racetrack, or visual representation of the determined virtual racing environment characteristics of the virtual racing environment and visual representation of the determined virtual racetrack characteristics of the virtual racetrack.

According to the invention the step a) comprises providing a 2-dimensional virtual racing environment comprising the virtual racetrack.

The 2-dimensional virtual racing environment enables fast and efficient processing and calculations.

Alternatively, according to the invention the step a) comprises providing a 3-dimensional virtual racing environment comprising the virtual racetrack.

The 3-dimensional virtual racing environment enables providing an environment corresponding the real-world racing environment.

According to the invention in the step a) the virtual racetrack comprises positioning data configured to define positions in the virtual racetrack, the positioning data comprising real-world coordinates configured to associate corresponding positions in the real-world racetrack with the defined positions in the virtual racetrack.

Alternatively, according to the invention in the step a) the virtual racetrack comprises positioning data defining positions in the virtual racetrack, the positioning data comprises virtual coordinates configured to represent positions in the virtual racetrack and real-world coordinates configured to represent positions in the real-world racetrack, the positioning data being configured to associate virtual coordinates with corresponding real-world racetrack.

Further alternatively according to the invention, in the step a) the virtual racetrack comprises positioning data comprising spatial mapping data configured to define positions of the virtual racetrack and corresponding real-world positions in the real-world racetrack.

Accordingly, the positioning data is configured to link or associate positions of the real-world racetrack with corresponding positions in the virtual racetrack. Thus, the position of the virtual racer model in the virtual racetrack may be defined and calculated to correspond the position of the real-world racer in the real-world racetrack.

According to the invention in the step b) the virtual racer model comprises a two-dimensional racer model representing the real-world racer.

Alternatively, according to the invention in the step b) the virtual racer model comprises a three-dimensional racer model representing the real-world racer.

Further alternatively, according to the invention in the step b) the virtual racer model comprises a three-dimensional racer model configured to correspond the real-world racer.

According to the invention in the step c) the controllable virtual racer is provided as a two-dimensional controllable racer model.

Alternatively, according to the invention the controllable virtual racer is provided as a three-dimensional controllable racer model.

According to the invention, the step d) comprises associating the received telemetry data with the virtual racer model.

The telemetry data is associated with the virtual racer model for calculating and determining position and speed of the virtual racer model in the virtual racetrack based on the telemetry data.

According to the invention, the real-world racer comprises one or more sensors configured to detect parameters of the real-world racer and to generate the telemetry data based on the detected parameters, the detected parameters comprise at least position and motion of the real-world racer detected by the one or more sensors.

The sensors provided to the real-world racer enable continuous, or continuous and instantaneous detection or measurement of the position and motion of the real-world racer in the real-world racetrack. Thus, movement of the virtual racer model in the virtual racetrack may be provided to correspond the position and motion of the real-world racer in the real-world racetrack.

According to the invention, the step d) comprises receiving, in the computer system, the telemetry data as continuous telemetry data from the real-world racer.

Continuous telemetry data enables calculating and updating position and speed of the virtual racer model in the virtual racetrack continuously.

Alternatively, according to the invention, the step d) comprises receiving, in the computer system, the telemetry data as streaming telemetry data from the real-world racer.

Streaming telemetry data enables calculating and updating position and speed of the virtual racer model in the virtual racetrack in real-time.

Further alternatively, according to the invention the step d) comprises receiving, in the computer system, the telemetry data as continuous streaming telemetry data from the real-world racer.

Continuous streaming telemetry data enables calculating and updating position and speed of the virtual racer model in the virtual racetrack continuously and in real-time.

Accordingly, the invention the step d) comprises receiving, in the computer system, the telemetry data as continuous real-time telemetry data from the real-world racer.

According to the invention, the step e) comprises receiving, in the computer system, the control data as continuous control data from the user device.

Alternatively, according to the invention the step e) comprises receiving, in the computer system, the control data as a response to user input from the user device.

Further alternatively, according to the invention the user device comprises one or more input devices configured to generate control data as a response to user input, and the step e) comprises receiving, in the computer system, the control data from the user device.

Yet alternatively, according to the invention the user device comprises one or more input devices configured to generate control data as a response to user input, and receiving, in the computer system, the control data as continuous control data from the user device.

Continuous control data enables calculating and updating position and speed of the controllable virtual racer in the virtual racetrack continuously.

According to the invention, the step d) comprises receiving, in the computer system, the control data as continuous real-time or continuous streaming control data from the user device. Continuous streaming or real-time control data enables calculating and updating position and speed of the controllable virtual racer in the virtual racetrack continuously and in real-time.

According to the invention, in the step e) the control data comprises at least motion control data, the motion control data defining motion of the controllable virtual racer in the virtual racing environment.

Thus, the movement of the controllable virtual racer is calculated or determined based on the control data.

Further, the computer system may be configured to calculate or determine the position of the controllable virtual racer in or along the virtual racetrack.

Alternatively, according to the invention in the step e) the control data comprises at least position data and motion control data, the motion control data defining position and motion of the controllable virtual racer in the virtual racing environment.

According to the invention, the step d) comprises receiving, in the computer system, the telemetry data as real-time telemetry data and the step f) comprises calculating continuously real-time position and speed of the virtual racer model in the virtual racetrack based on the real-time telemetry data.

Accordingly, this enables playing the race game in real-time or nearly real-time during the real-world race.

Alternatively, according to the invention the step d) comprises storing, in the computer system, the received telemetry data as stored telemetry data, and the step f) comprises calculating continuously instantaneous position and speed of the virtual racer model in the virtual racetrack based on the stored telemetry data.

Accordingly, this enables playing the race game any time during or after the real-world race and against the real-world races.

According to the invention the step e) comprises receiving, in the computer system, the control data as real-time control data, and the step g) comprises calculating continuously real-time position and speed of the controllable virtual racer in the virtual racetrack based on the real-time control data.

Thus, the controllable virtual racer is moved in or along the virtual racetrack simultaneously during the real-world race.

Alternatively, according to the invention the step g) comprises calculating continuously instantaneous position and speed of the controllable virtual racer based on the received control data.

According to the invention, the step h) comprises continuously generating visual representation of the virtual environment representing simultaneously instantaneous position and speed of the virtual racer model and the controllable virtual racer in the virtual racetrack based on the calculated position and speed of the virtual racer model and the calculated position and speed of the controllable virtual racer.

Therefore, the visual representation of the virtual environment is continuously updated for enabling active playing.

Alternatively, according to the invention the step h) comprises generating real-time visual representation of the virtual environment representing simultaneously real-time position and speed of the virtual racer model and the controllable virtual racer in the virtual racetrack based on the calculated position and speed of the virtual racer model and the calculated position and speed of the controllable virtual racer.

Therefore, the visual representation of the virtual environment is configured to represent real-time race in the real-world racetrack together with the controllable virtual racer.

According to the invention, the step h) further comprises receiving the generated visual representation in the user device, and presenting the generated visual representation in a display device provided in connection with the user device.

Alternatively, according to the invention the step h) comprises receiving the generated visual representation in the user device as streaming visual representation data, and presenting the generated visual representation data continuously in a display device provided in connection with the user device.

The visual representation is updated continuously and continuously presented with the display device. Thus, the display device is configured to continuously present the continuously updated visual representation.

Further alternatively, according to the invention the step h) comprises receiving the generated real-tie visual representation in the user device as real-time visual representation data, and presenting the generated real-time visual representation data continuously in a display device provided in connection with the user device.

The visual representation is updated continuously in real-time and continuously presented with the display device in real-time. Thus, the display device is configured to continuously present the continuously in real-time updated visual representation.

According to the invention, the step h) comprises time synchronizing the position and speed of the virtual racer model and the position and speed of the controllable virtual racer in the visual representation.

Alternatively, according to the invention the step h) comprises time synchronizing the position and speed of the virtual racer model and the position and speed of the controllable virtual racer before generating the visual representation.

Time synchronization enables time synchronization of the controllable virtual racer with the position and movement of the real-world racers enabling racing against the real-world racers in the virtual racing environment in time exact manner.

The telemetry data is provided with telemetry time data defining timepoints for each data point of the telemetry data. Similarly, the control data is provided with control time data defining timepoints for each data point of the control data. The telemetry time data and control time data are utilized for time synchronizing the position and speed of the virtual racer model and the position and speed of the controllable virtual racer before generating the visual representation.

According to the invention, the method comprises in step b) providing two or more virtual racer models representing two or more real-world racers, respectively, in step d) receiving, in the computer system, telemetry data from two or more real-world racers moving on the real-world racetrack associating the telemetry data received from each of the real-world racers with one of the two or more virtual racer models, the telemetry data comprising at least position data and motion data of the real-world racer, in step f) calculating position and speed of each of the virtual racer models in the virtual race track based on the telemetry data associated with the virtual racer model, and in step h) generating the visual representation of the virtual environment representing the two or more virtual racer models together the controllable virtual racer in the virtual racetrack based on the calculated position and speed of each of the two or more virtual racer models and the calculated position and speed of the controllable virtual racer.

This enables playing the game against two or more real-world racers in the virtual racing environment simultaneously.

According to the invention the method comprises i) receiving, in the computer system, environmental measurement data from one or more environmental sensors provided in connection with the real-world racetrack, calculating racetrack data by utilizing the environmental measurement data, and determining virtual racing environment characteristics of the virtual racing environment or virtual racetrack characteristics of the virtual racetrack based on the calculated racetrack data.

The environmental measurement data enables generating a more authentic virtual racing environment based on the environmental measurement data.

According to the invention the method comprises in the step h) generating the visual representation of the virtual racing environment by utilizing the calculated racetrack data, the virtual racing environment comprising visual representation of the determined virtual racing environment characteristics of the virtual racing environment or visual representation of the determined virtual racetrack characteristics of the virtual racetrack.

The visual representation of the virtual racing environment or the virtual racetrack is provided to represent the virtual racing environment characteristics by utilizing the environmental measurement data.

The present invention also based on the idea of providing a system for mixed-reality race game, the system comprising a computer system comprising instructions which when executed on at least one processor of the computer system cause the computer system to perform mixed-reality race game in a network, and a user device connectable to the computer system in the network. The computer system is configured to:
a) provide a virtual racing environment comprising a virtual racetrack, the virtual racetrack being a virtual representation of a real-world racetrack,
b) provide a virtual racer model representing a real-world racer,
c) provide a controllable virtual racer,
d) receive, in the computer system, telemetry data from the real-world racer moving on the real-world racetrack, the telemetry data comprising at least position data and motion data of the real-world racer, and associating telemetry data of the real-world racer with the virtual racer model,
e) receive, in the computer system, control data from the user device, and associating the control data with the controllable virtual racer,
f) calculate position and speed of the virtual racer model in the virtual racetrack based on the telemetry data associated with the virtual racer model,
g) calculate position and speed of the controllable virtual racer in the virtual racetrack based on the control data associated with the controllable virtual racer, and
h) generate a visual representation of the mixed-reality race game comprising the virtual environment representing the virtual racer model together with the controllable virtual racer in the virtual racetrack based on the calculated position and speed of the virtual racer model and the calculated position and speed of the controllable virtual racer.

The computer system is further configured to:
i) receive environmental measurement data from one or more environmental sensors provided in connection with the real-world racetrack, and
j) modify the control data associated with the controllable virtual racer based on the environmental measurement data and generating modified control data based on modifying the control data, and
in g) the computer system is configured to calculate position and speed of the controllable virtual racer in the virtual racetrack based on the modified control data associated with the controllable virtual racer.

The system enables a mixed-reality race game in which the human user is able to play against real-world racers of a real-world race. Accordingly, the system enables the user operating the controllable virtual racer to be able to take part in the real-world race in the virtual environment by operating the controllable virtual racer among virtualized real-world racers. Further, modifying the control data based on the environmental measurements from the sensor(s) provided in connection with the real-world race enables the virtual racer to move in more realistic manner taking into account the environmental characteristics in the real-world racetrack.

According to the invention, the system comprises one or more real-world racers comprising one or more sensors configured to detect parameters of the real-world racer and to generate the telemetry data based on the detected parameters, the detected parameters comprise at least position and motion of the real-world racer model detected by the one or more sensors.

The sensors provided to the real-world racer enable detecting position and speed of the real-world racer and further determining the position of the virtual racer model in the virtual racing environment.

According to the invention the user device comprises one or more input devices configured to generate control data as a response to user input.

The input devices enable the user to control the controllable virtual racer in the virtual racing environment.

In some embodiments, the system comprises one or more environmental sensors provided in connection with the real-world racetrack and configured to the generate environmental measurement data, and the computer system is configured to receive the environmental measurement data from one or more environmental sensors, calculate racetrack data by utilizing the environmental measurement data, and to determine virtual racing environment characteristics of the virtual racing environment or virtual racetrack characteristics of the virtual racetrack based on the calculated racetrack data.

The environmental sensors enable generating a more authentic virtual racing environment based on the environmental measurement data.

In some other embodiments, the system comprises one or more environmental sensors provided in connection with the real-world racetrack and configured to the generate the environmental measurement data, and the computer system is configured to receive the environmental measurement data from one or more environmental sensors, calculate racetrack data by utilizing the environmental measurement data, and to determine virtual racing environment characteristics of the virtual racing environment, virtual racetrack characteristics of the virtual racetrack or virtual racing environment characteristics of the virtual racing environment and virtual racetrack characteristics of the virtual racetrack based on the calculated racetrack data.

According to the invention the system comprises a display device configured to present the visual representation of the mixed-reality race game.

Alternatively, according to the invention the user device comprises a display device configured to present the visual representation of the mixed-reality race game.

According to the invention the system is configured to carry out the method as disclosed above.

The present invention further provides a computer program product, characterized in that the computer program product comprises instructions, which, when executed by a computing system, cause the computing device to perform a method according to above disclosed.

The computer program product is operable to receive the telemetry data, the control data and environmental measurement data.

An advantage of the invention is that it provides a multiplayer game in which only one human player is needed to take part in the computer game. The present invention also enables the human player to take part in the real-world race in real-time and race against the real-world racers during the real-world race.

### BRIEF DESCRIPTION OF THE DRAWINGS

The invention is described in detail by means of specific embodiments with reference to the enclosed drawings, in which

FIG. 1 shows schematically a real-world racetrack with real-world racers;

FIG. 2 shows schematically a real-world racer;

FIG. 3 shows schematically a racer data unit of a real-world racer;

FIGS. 4 and 5 show schematically user devices;

FIGS. 6 and 7 show schematically different embodiments of the system according to the present invention;

FIG. 8 shows schematically software structure according to the present invention;

FIGS. 9 and 10 show schematically visual representations of the mixed-reality race game; and

FIG. 11 shows schematically the method of the present invention.

### DETAILED DESCRIPTION OF THE INVENTION

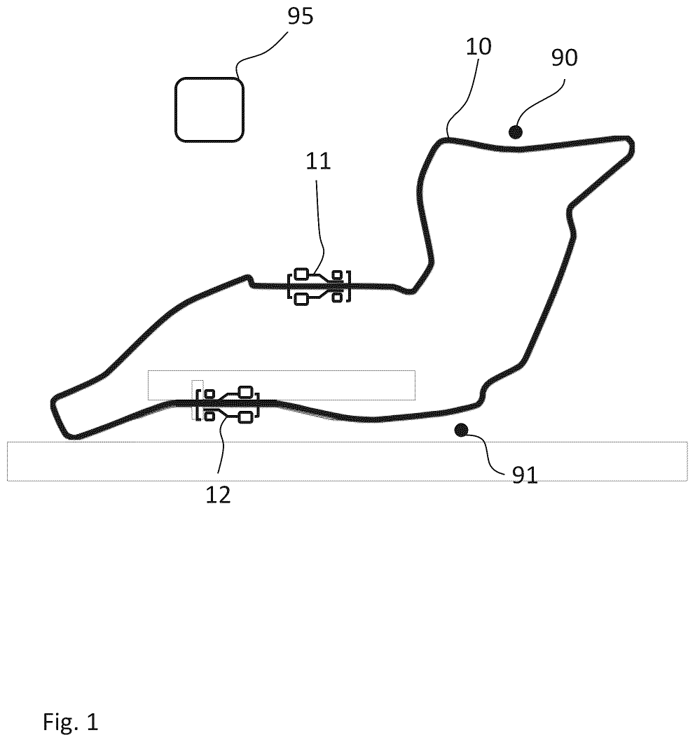

FIG. 1 shows schematically a real-world racing event. The real-world racing event is carried out in a real-world racetrack 10. One or more real-world racers 11, 12 are moving in or along the real-world racetrack 10 during the real-world race.

The real-world racetrack 10 can be any racetrack such as a motor sport racetrack, a cycling racetrack, or any other real-world race track having a defined physical shape and length. The real-world racetrack 10 may be an unending racetrack forming a loop or a lap. Alternatively, the real-world racetrack 10 may be a racetrack comprising a start and finish provided in different geographical locations.

The real-world racer 11, 12 may be any kind of racer such as a car, a motorcycle, a bike, or the like. The real-world racer comprises or is provided with one or more sensors configured to detect parameters of the real-world racer 11, 12 and to generate telemetry data based on the detected parameters during the movement of the real-world racer 11, 12 in or along the real-world racetrack 10. The detected parameters comprise at least position and motion of the real-world racer 11, 12 detected by the one or more sensors.

In the context of this application telemetry data means data of the real-world racer collected with the one or more sensors provided to or in connection with the real-world racer 11, 12 during the movement of the real-world racer 11, 12 in the real-world racetrack 10.

The telemetry data comprises at least position data and motion data of the real-world racer 11, 12 measured with the one or more sensors provided to or in connection with the real-world racer 11, 12.

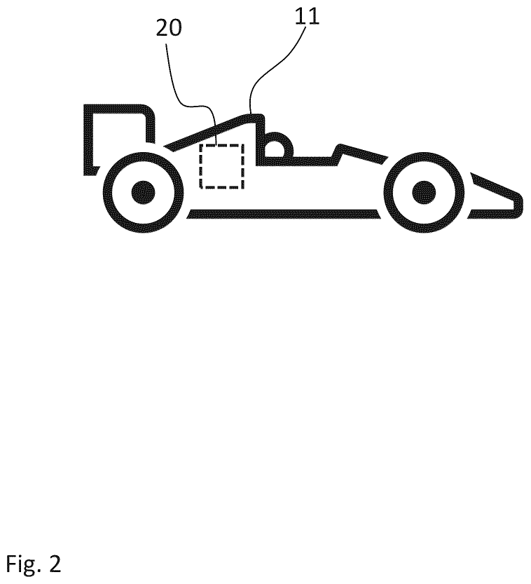

FIG. 2 shows schematically a real-world racer 11. The real-world racer 11 comprises a racer data unit 20. The racer data unit 20 is configured to generate or measure telemetry data, and further transmit the telemetry data to an external computer system. The racer data unit 20 comprises the one or more sensors configured to detect the parameters of the real-world racer 11 during the movement of the real-world racer 11.

It should be noted that the one or more sensors and other components of the racer data unit 20 may be distributed to different locations in the real-world racer 11 or provided in a structurally compact unit.

As shown in FIG. 1, the real-world racetrack 10 is further provided with one or more environmental sensors 90, 91. The one or more environmental sensors 90, 91 are configured to generate or measure environmental measurement data of the real-world racetrack 10.

In some embodiments, the one or more environmental sensors 90, 91 comprise racetrack sensors configured to generate or measure environmental measurement data of the real-world racetrack 10.

In some embodiments, the environmental sensors 90, 91, or racetrack sensors, comprise at least humidity sensor(s) configured to detect and/or measure humidity or water on the real-world racetrack 10.

In some embodiments, the environmental sensors 90, 91, or racetrack sensors, comprise at least temperature sensor(s) configured to detect and/or measure temperature of the real-world racetrack 10.

In some embodiments, the one or more environmental sensors 90, 91 comprise weather sensors configured to generate or measure environmental measurement data from the real-world racetrack 10. The environmental sensors 90, 91, or weather sensors, comprise at least humidity sensor(s) configured to detect and/or measure humidity of the real-world racetrack 10 or rain sensor(s) configured to detect and/or measure rain in the real-world racetrack 10.

In some embodiments, environmental sensors 90, 91, or weather sensors, comprise additionally or instead of humidity and rain sensor(s), wind sensor(s) configured to detect or measure wind speed or speed and direction of the wind in the real-world racetrack 10, and/or temperature sensor(s) configured to measure temperature of the real-world racetrack 10 and/or temperature of the atmosphere in the real-world racetrack 10.

In some embodiments, environmental sensors 90, 91 comprise additionally or instead of the above mentioned sensors(s) one or more cameras configured to generate image data or video data from the real-world racetrack 10.

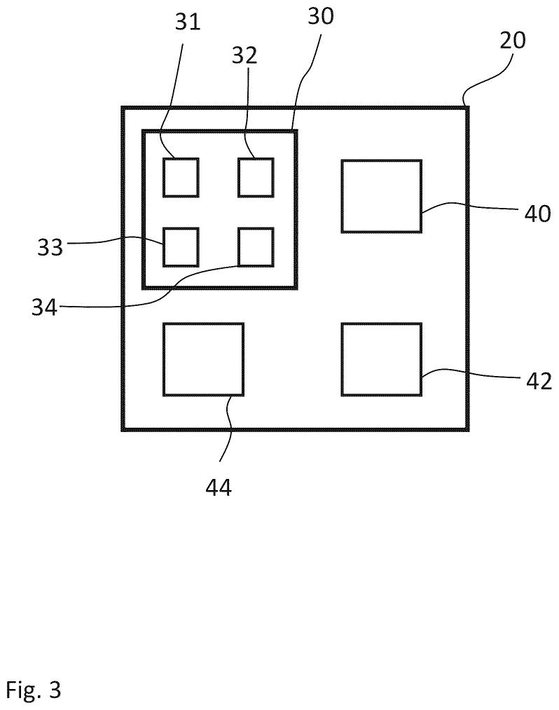

FIG. 3 shows schematically the racer data unit 20. The racer data unit 20 comprises a sensor module 30 comprising one or more sensors configured to detect and measure parameters of the real-world racer 11, 12 and to generate telemetry data based on the detected parameters during the movement of the real-world racer 11, 12 in or along the real-world racetrack 10.

The sensor module 30 may comprise at least sensors for detecting position and motion of the real-world racer 11, 12 in or along the real-world racetrack 10. Thus, the sensor module 30 is configured to generate position data and motion data of the real-world racer 11, 12 during movement in the real-world racetrack 10.

The sensor module 30 may comprise one or more position sensors 31 configured to detect position of the real-world racer 11, 12 in or along the real-world racetrack 10.

The position sensor 31 may be a navigation satellite receiver configured to detect or measure the position of the real-world racer 11, 12, such as a GPS sensor (Global Positioning System sensor), or optical position sensor(s) configured to detect or measure the position of the real-world racer 11, 12. It should be noted that the position sensor(s) 31 may be any kind of position sensor capable of detecting or measuring position of the real-world racer 11, 12 in or along the real-world racetrack 10.

The one or more position sensors are configured to continuously detect or measure the position of the real-world racer 11, 12 in or along the real-world racetrack 10.

The one or more position sensors are configured to continuously detect or measure instantaneous position of the real-world racer 11, 12 in or along the real-world racetrack 10.

Preferably, the one or more position sensors 31 are configured to continuously detect or measure instantaneous position of the real-world racer 11, 12 in or along the real-world racetrack 10 with time intervals of 1 s or less. Accordingly, the one or more position sensors 31 are configured to detect or measure instantaneous position of the real-world racer 11, 12 in or along the real-world racetrack 10 with output rate of at least 20 Hz (50 ms update rate), or with output rate of at least 60 Hz (16.7 ms update rate), or preferably with output rate of at least 120 Hz (8.3 ms update rate), or more preferably with output rate of at least 200 Hz (5 ms update rate).

The one or more position sensors 31 are configured to generate position data. The telemetry data comprises the position data.

The one or more position sensors 31 or the output thereof may be configured to measure or calculate speed of the real-world racer 11, 12 in or along the real-world racetrack 10 based on the detected or measured position of the real-world racer 11, 12 or based on the position data. Accordingly, the position data may be utilized for calculating speed of the real-world racer 11, 12 in or along the real-world racetrack 10.

The sensor module 30 may comprise one or more motion sensors 32 configured to detect motion of the real-world racer 11, 12 in or along the real-world racetrack 10. The one or more motion sensors 32 are configured to detect at least speed of the real-world racer 11, 12. Alternatively, the one or motion sensors 32 are configured to detect at least speed and acceleration of the real-world racer 11, 12.

The one or more motion sensors 32 may comprise one or more of the following: accelerometer, gyroscope, position sensor, optical sensor, configured to detect or measure speed or speed and acceleration of the real-world racer 11, 12. It should be noted that the motion sensor(s) 32 may be any kind of motion sensor capable of detecting or measuring speed and or speed and acceleration of the real-world racer 11, 12 in or along the real-world racetrack 10.

The one or more motion sensors 32 are configured to continuously detect or measure the motion of the real-world racer 11, 12 in or along the real-world racetrack 10.

The one or more motion sensors 32 are configured to continuously detect or measure instantaneous speed or speed and acceleration of the real-world racer 11, 12 in or along the real-world racetrack 10.

Preferably, the one or more motion sensors 32 are configured to continuously detect or measure instantaneous speed or speed and acceleration of the real-world racer 11, 12 in or along the real-world racetrack 10 with time intervals of 1 s or less. Accordingly, the one or more motion sensors 32 are configured to detect or measure instantaneous speed or speed and acceleration of the real-world racer 11, 12 in or along the real-world racetrack 10 with output rate of at least 20 Hz (50 ms update rate), or with output rate of at least 60 Hz (16.7 ms update rate), or preferably with output rate of at least 120 Hz (8.3 ms update rate), or more preferably with output rate of at least 200 Hz (5 ms update rate).

The one or more motion sensors 32 are configured to generate motion data. The telemetry data comprises the motion data. The motion data may comprise speed data or speed data and acceleration data.

In some embodiments, the sensor module 30 may further comprise one or more orientation sensors 33 configured to detect or measure orientation or change of orientation of the real-world racer 11, 12.

Orientation of the real-world racer 11, 12 means orientation of the real-world racer 11, 12 in relation to the real-world racetrack 10.

Alternatively or additionally, the orientation of the real-world racer 11, 12 means orientation of the real-world racer 11, 12 in relation to the real-world racetrack 10 and in relation to compass points (or compass directions or north direction).

The one or more orientation sensors 33 comprise one or more of the following: accelerometer, gyroscope, optical orientation sensor, configured to detect or measure orientation or direction or orientation of the real-world racer 11, 12. It should be noted that the orientation sensor(s) 33 may be any kind of orientation sensor capable of detecting or measuring orientation of the real-world racer 11, 12 in or along the real-world racetrack 10.

The one or more orientation sensors 33 are configured to continuously detect or measure the orientation of the real-world racer 11, 12 in or along the real-world racetrack 10.

The one or more orientation sensors 33 are configured to continuously detect or measure instantaneous orientation of the real-world racer 11, 12 in or along the real-world racetrack 10.

Preferably, the one or more orientation sensors 33 are configured to continuously detect or measure instantaneous orientation of the real-world racer 11, 12 in or along the real-world racetrack 10 with time intervals of 1 s or less. Accordingly, the one or more orientation sensors 33 are configured to detect or measure instantaneous orientation of the real-world racer 11, 12 in or along the real-world racetrack 10 with output rate of at least 20 Hz (50 ms update rate), or with output rate of at least 60 Hz (16.7 ms update rate), or preferably with output rate of at least 120 Hz (8.3 ms update rate), or more preferably with output rate of at least 200 Hz (5 ms update rate).

The one or more orientation sensors 33 are configured to generate orientation data. The telemetry data comprises the orientation data.

In some embodiments, the sensor module 30 further comprises one or more instrumentation sensors 34 configured to detect or measure technical racer properties of the real-world racer 11, 12 during movement in or along the real-world racetrack 10.

The one or more instrumentation sensors 34 are configured to detect or measure any technical properties of the real-world racer 11, 12 such as operation of racer technical systems and/or input of a human driver of the real-world racer 11, 12 via racer input devices such as accelerator, brakes, and/or steering device.

It should be noted that the instrumentation sensor(s) 34 may be any kind of instrumentation sensor capable of detecting or measuring technical properties of the real-world racer 11, 12 in or along the real-world racetrack 10.

The one or more instrumentation sensors 34 are configured to continuously detect or measure the technical properties or instantaneous technical properties of the real-world racer 11, 12 in or along the real-world racetrack 10.

The one or more instrumentation sensors 34 are configured to continuously detect or measure instantaneous technical properties of the real-world racer 11, 12 in or along the real-world racetrack 10.

Preferably, the one or more instrumentation sensors 34 are configured to continuously detect or measure instantaneous technical properties of the real-world racer 11, 12 in or along the real-world racetrack 10 with time intervals of 1 s or less. Accordingly, the one or more instrumentation sensors 34 are configured to detect or measure instantaneous technical properties of the real-world racer 11, 12 in or along the real-world racetrack 10 with output rate of at least 20 Hz (50 ms update rate), or with output rate of at least 60 Hz (16.7 ms update rate), or preferably with output rate of at least 120 Hz (8.3 ms update rate), or more preferably with output rate of at least 200 Hz (5 ms update rate).

The one or more instrumentation sensors 34 are configured to generate instrumentation data. The telemetry data comprises the instrumentation data.

The real-world racer 11, 12 and the sensor module 30 thereof may also comprise additional sensors configured to generate additional measurement data. The telemetry data may comprise the additional measurement data.

The racer data unit 20 further comprises a racer communication module 40 configured to provide communication connection with a computer system. The communication module 40 is configured to transmit telemetry data from the real-world racer 11, 12 to the external computer system. The racer data unit 20 further comprises a memory 42 comprising instructions to operate the sensor module 30 and the sensors 31, 32, 33, 34, process the sensors measurement data and/or the telemetry data and operate the communication module 40 to transmit the telemetry data. The racer data unit 20 also comprises one or more processors 44 for carrying out the instructions stored to the memory 42.

The communication module 42 may be any known communication module configured to carry out data transmission to the external computer system or data transfer between the external computer system and the racer data unit 20. The communication module may be for example one of the Internet communication module, mobile network communication module, a local area network (LAN) communication module, or a wide area network (WAN) communication module or any other suitable communication module. The present invention is not restricted to any type of communication module 42.

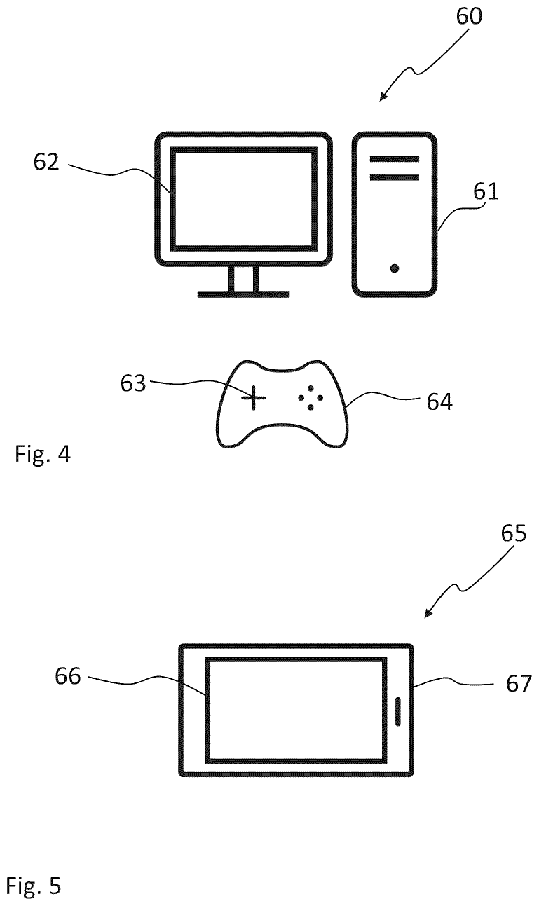

FIGS. 4 and 5 show schematically different user devices. The user device may be a personal computer, laptop, mobile user device, game console, virtual reality device, or any other user device suitable for playing the racing game.

FIG. 4 shows a game console 60 as the user device. The user device 60 comprises a display device 62 and a user input device 64 having one or more user input elements 63. The user input device 64 is configured to generate control data as a response to user inputs. The user device 60 further comprises a display device 62 configured to present a virtual racing environment and/or a visual representation of the mixed-reality racing game according to the invention. The user device 60 further comprises a central unit 61. The display device 62 is connected, with a wire or wirelessly, to the central unit 61 for receiving the visual representation from the central unit 61. The user input device 64 is connected, with a wire or wirelessly, to the central unit 61 and configured to provide the control data to the central unit 61.

The central unit 61 comprises at least a user device memory comprising instructions for operating the display device 62 and the user input device 64. The central unit 61 may further comprises at least one user device processor configured to carry out the instructions.

The display device 62 may be any kind of display device, such as a computer display or television.

The user input unit 64 may be any kind of user input device, such as a keyboard, a computer mouse, a game controller, or the like.

FIG. 5 shows an alternative user device 65. The user device 65 comprises an integrated display device 66. The user device 65 further comprises central unit 67 as integral part of the user device 65. The central unit 67 comprises at least a user device memory comprising instructions for operating the display device 66 and the user input device. The central unit 67 may further comprises at least one user device processor configured to carry out the instructions.

The display device 66 is provided as a touchscreen configured to provide also the user input device. The display device 66 is configured to generate control data as a response to user inputs via the touchscreen.

Alternatively or additionally, the central unit 67 comprises one or more motion sensors configured to generate motion data based on the motion or orientation of the user device 65. The motion sensors may comprise one or more of the following: accelerometer, gyroscope and magnetometer, or any other motion sensors capable of detecting motion or orientation of the user device 65. Accordingly, the user device 65 itself, or the motion sensors thereof, form the user input device. The user device 65 is configured to generate control data as a response to moving of the user device 65 by the user.

The user device 65 may be a mobile user device, such as a mobile phone.

The user devices 60, 65 or the central unit 61, 67 thereof comprises a user device communication module for data transfer with an external computer system. The user device communication module may be any known communication module configured to carry out data transfer between the external computer system and the user device 60, 65. The user device communication module may be for example one of the Internet communication module, mobile network communication module, a local area network (LAN) communication module, or a wide area network (WAN) communication module, or a WiFi communication module, or a Bluetooth communication module or any other suitable communication module. The present invention is not restricted to any type of user device communication module.

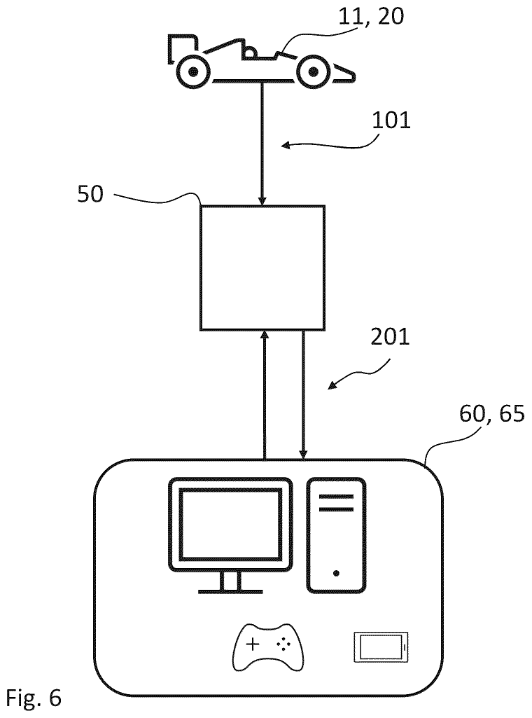

FIG. 6 shows one embodiment of the system of the invention. The system comprises a computer system 50. The computer system 50 is configured to receive the telemetry data from the one or more real-world racers 11 or the racer data units 20 thereof over a first network connection 101. The computer system 50 is also configured to receive the control data from the user device 60, 65 over a second network connection 201.

The first and second network connections 101, 201 may be, for example, any one of the Internet, mobile network, a local area network (LAN), or a wide area network (WAN), or some other communication network. In addition, the first and second network connections 101, 201 may be implemented by a combination thereof. The present invention is not restricted to any type of communication network or network connection.

The computer system 50 is configured to carry out the method steps and processing steps of the present invention and generate a visual representation of a mixed-reality race game. The user device 60, 65 is configured to receive the visual representation via the second network connection 201. The user device 60, 65 is further configured to present the visual representation with the display device 62, 66.

The computer system 50 may comprise one or more servers, which may include cloud server(s), physical server(s), distributed servers or the like server devices, one or more computers or computer devices. The computer system 50 may be any known type of computer system or computer device or a combination thereof. The present invention is not restricted to any type of computer device 50.

The computer system 50 comprises one or more processors and one or more memories. A software module is stored in the one or more memories. The software module comprises instructions to be carried out by the one or more processors of the computer system 50.

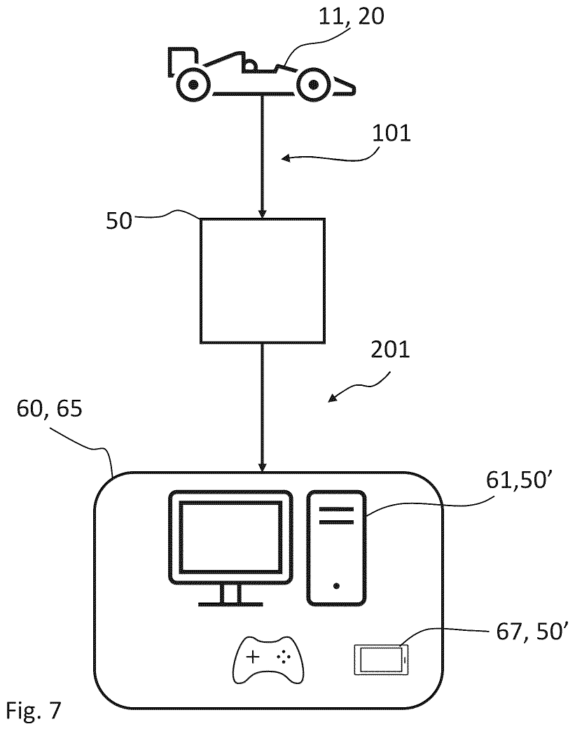

FIG. 7 shows an alternative embodiment of the system according to the invention. In this embodiment, the method and processing is distributed between the external computer 50 and the user device 60, 65. Accordingly, the computer system comprises the external computer system 50, as in FIG. 6, and the user device 60, 65, or the central unit 61, 67 thereof. The central unit 61, 67 is configured to provide an internal computer system 50′.

In the embodiment of FIG. 7, the external computer system 50 is configured to receive the telemetry data from the one or more real-world racers 11 or the racer data units 20 thereof over the first network connection 101. The user device 60, 65 or the central unit 61, 67, or the internal computer system 50′, is configured to receive the control data from the user device 60, 65 or from the user input device 64, 66 thereof.

The external computer system 50 and the internal computer system 50′ together form the computer system 50, 50′ according to the invention. The method steps or process steps of the invention may be distributed between the external computer system 50 and the internal computer system 50′.

The telemetry data may be further received in the user device 60, 65 via the second network connection 201 from the external computer system 50.

Alternatively, the calculations based on the telemetry data may be carried out in the external computer system 50 and the calculation output may be received in the user device 60, 65 or the internal computer system 50′ for further processing.

Accordingly, the processing and method steps of the invention may be distributed between the external computer system 50 and the internal computer system 50′.

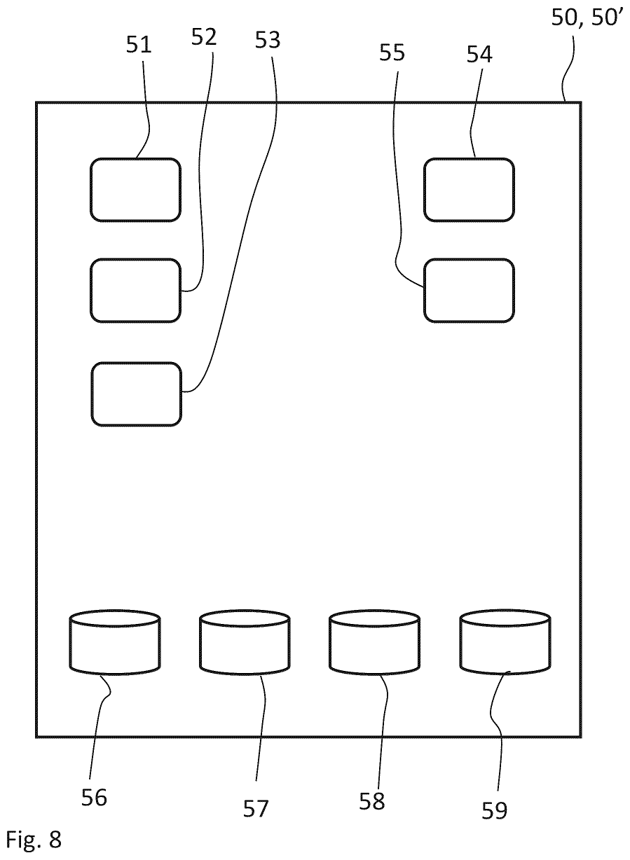

FIG. 8 is a schematic configuration example of the software module which operates the computer system 50, 50′. The computer system 50, 50′ is configured to carry out the method steps of the present invention by utilizing the software module of the computer system 50, 50′.

The computer system 50 and the software module thereof comprises an input unit 51. The input unit 51 is configured to receive the telemetry data and the control data. The input unit 51 is configured to receive the telemetry data from the one or more real-world racers 11,12. The input unit 51 is configured to receive the control data from the user device 60, 65.

The computer system 50, 50′ and the software module thereof comprises a real-world racer processing unit 53 configured to associate the telemetry data with a virtual racer model 72, 73 and calculate position and speed of the virtual racer model 72, 73 in a virtual racetrack 71 in a virtual racing environment 70 based on the telemetry data associated with the virtual racer model 72, 73.

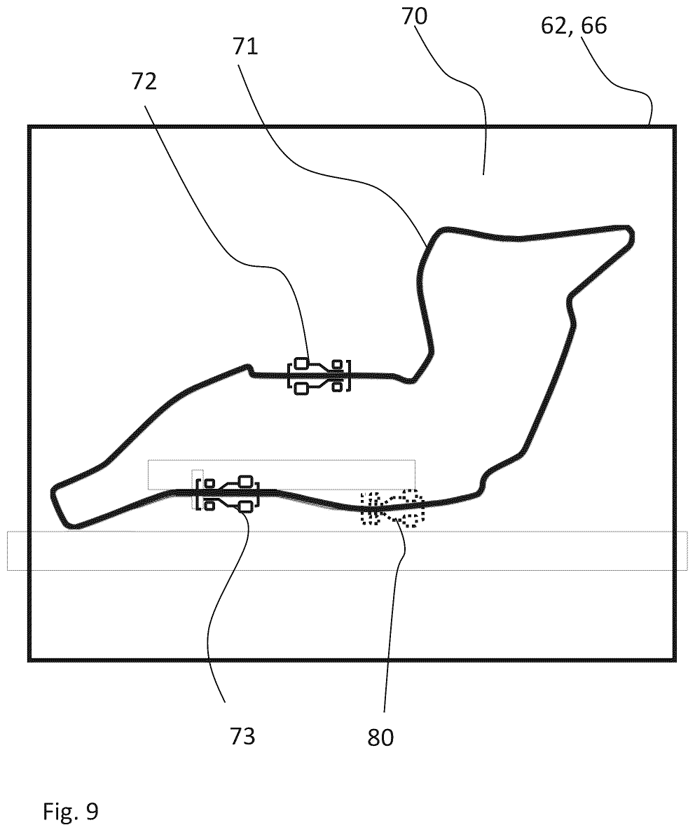

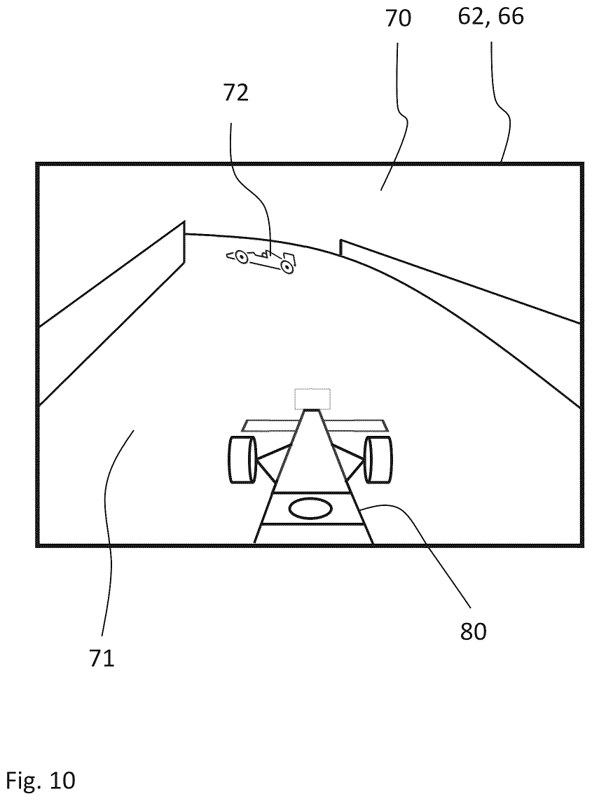

The virtual racer model 72, 73 is configured to represent the real-world racer 11, 12, as shown in FIGS. 9 and 10.

The virtual racetrack 71 is configured to represent and correspond to the real-world racetrack 10 in the virtual racing environment 70. The virtual racetrack 71 is digital twin or digital representation or a digital replica of the real-world racetrack 10.

The computer system 50, 50′ and the software module thereof comprises a controllable virtual racer processing unit 54 configured to provide a controllable virtual racer 80, associating the control data with the controllable virtual racer 80 and calculate position and speed of the controllable virtual racer 80 in the virtual racetrack 71 in the virtual racing environment 70 based on the control data associated with the virtual racer model 72, 73.

The computer system 50, 50′ and the software module thereof comprises a virtualization unit 55 configured to provide the virtual racing environment 70 and the virtual racing track 71. The virtualization unit 55 is further configured to generate the visual representation of the race game comprising the virtual racing environment 70 representing the virtual racer model 72, 73 together the controllable virtual racer 80 in the virtual racetrack 71 based on the calculated position and speed of the virtual racer model 72, 73 and the calculated position and speed of the controllable virtual racer 80.

The computer system 50, 50′ and the software module thereof comprises an output unit 52 configured to transmit visual representation as output data from the computer system 50, 50′.

The output unit 52 configured to transmit the visual representation from the computer system 50, 50′ to the user device 60, 65.

The computer system 50, 50′ and the software module thereof comprises a virtual racer model database 56. The virtual racer model database 56 is configured to store one or more virtual racer models 72, 73 configured to represent one or more real-world racers 11, 12.

The computer system 50, 50′ and the software module thereof comprises a telemetry database 57. The telemetry database 57 is configured to store telemetry data received in the computer system 50, 50′.

The computer system 50, 50′ and the software module thereof comprises a virtual racetrack database 58. The virtual racetrack database 58 is configured to store one or more virtual racetracks 71 or one or more virtual racing environments 70 comprising the virtual racetrack 71.

The computer system 50, 50′ and the software module thereof comprises a controllable virtual racer database 59. The controllable virtual racer database 59 is configured to store one or more controllable virtual racers 80.

FIG. 9 shows schematically a 2-dimensional visual representation a mixed-reality race game comprising the virtual racing environment 70 representing the virtual racer model 72, 73 together with the controllable virtual racer 80 in the virtual racetrack 71 based on the calculated position and speed of the virtual racer model 72, 73 and the calculated position and speed of the controllable virtual racer 80.

FIG. 10 shows schematically a 3-dimensional visual representation a mixed-reality race game comprising the virtual racing environment 70 representing the virtual racer model 72 together the controllable virtual racer 80 in the virtual racetrack 71 based on the calculated position and speed of the virtual racer model 72 and the calculated position and speed of the controllable virtual racer 80.

The 2-dimensional visual representation and the 3-dimensional visual representation are configured to be presented by the display device 62, 66 of the user device 60, 65.

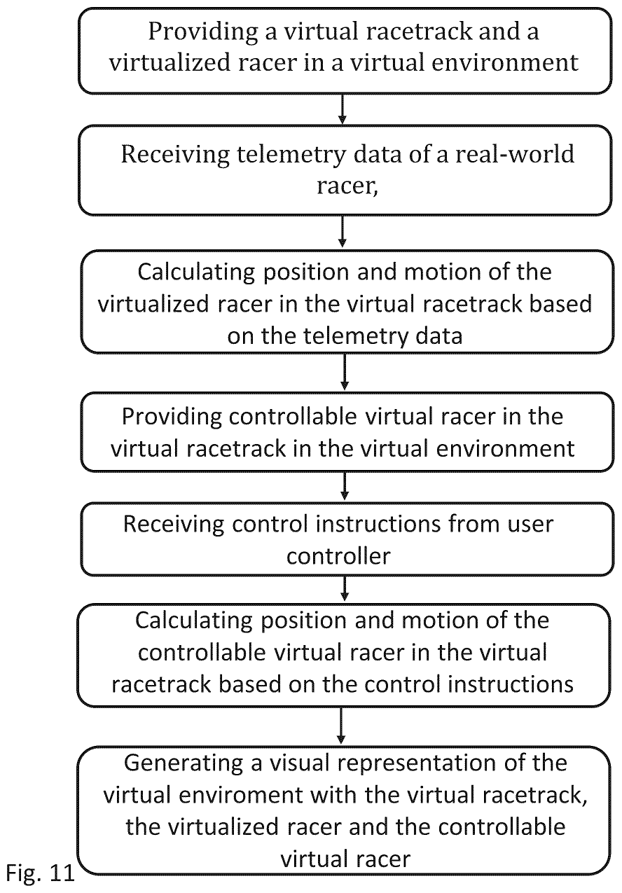

FIG. 11 discloses the main steps of the method of the present invention.

The method comprises providing the virtual racing environment 70 comprising the virtual racetrack 71. The virtual racetrack 71 being a virtual representation of a real-world racetrack 10. The virtual racetrack 71 is provided from the virtual racetrack database 58.

The method comprises providing a virtual racer model 72, 73 representing a real-world racer 11, 12. The virtual racer model 72, 73 being a virtual representation of a real-world racer 11, 12. The virtual racer model 72, 73 is provided from the virtual racer model database 56.

The method further comprises receiving telemetry data from the real-world racer 11, 12. The telemetry data is associated with the virtual racer model 72, 73.

Each real-world racer 11, 12 provides individual telemetry data and the telemetry data of each of the real-world racers 11, 12 is associated with one virtual racer model 72, 73 representing the real-world racer 11, 12. The telemetry data may comprise a racer identifier and the telemetry data is associated with the specific virtual racer model 72, 73 based on the racer identifier. The virtual racer model 72, 73 in the virtual racer model database 56 may comprise a corresponding model identifier and the telemetry data is associated with the specific virtual racer model 72, 73 based on the racer identifier and the model identifier.

The method further comprises calculating position data and motion data of the virtual racer model 72, 73, or the virtualized racer, in the virtual racetrack 71 based on the telemetry data. Accordingly, the position and motion of the virtual racer model 72, 73 in the virtual racetrack 71 is calculated to correspond the position and motion of the real-world racer 11, 12 in the real-world racetrack 10.

Therefore, the virtual racer model 72, 73 in the virtual racetrack 71 becomes a virtualized racer representing the movement of the real-world racer 11, 12 in the real-world racetrack 10.

The telemetry data is preferably received as continuous telemetry data defining continuously at least the position and speed of the real-world racer 11, 12 or continuously at least the instantaneous position and speed of the real-world racer 11, 12 in the real-world racetrack 10. Accordingly, the method comprises calculating continuously instantaneous position and speed of the virtual racer model 72, 73 in the virtual racetrack 71 based on the telemetry data.

The telemetry data may be received real-tie telemetry and calculating continuously position and speed of the virtual racer model 72, 73 may be carried out continuously in real-time based on the received real-time telemetry data.

Alternatively, the telemetry data may be stored to the telemetry database 57 and calculating continuously position and speed of the virtual racer model 72, 73 may be carried out based on the telemetry data stored to the telemetry database 57.

The method also comprises providing the controllable virtual racer 80. The virtual racer 80 is provided from the controllable virtual racer database 59. The virtual racer 59 is configured to be controllable by the user with the user device 60, 65 or the user input device 64, or controller, thereof.

The method further comprises receiving control data from the user device 60, 65 and associating the control data with the controllable virtual racer 80.

The method further comprises calculating position and speed of the controllable virtual racer 80 in the virtual racetrack 71 based on the received control data associated with the controllable virtual racer 80.

The control data is preferably received as continuous control data defining continuously at least the position and speed of the controllable virtual racer 80 or continuously at least the instantaneous position and speed of controllable virtual racer 80 in the virtual racetrack 71. Accordingly, the method comprises calculating continuously instantaneous position and speed of the controllable virtual racer 80 in the virtual racetrack 71 based on the control data.

The method further comprises generating a visual representation of the mixed-reality race game comprising the virtual racing environment 70 representing the virtual racer model 72, 73 together with the controllable virtual racer 80 in the virtual racetrack 71 based on the calculated position and speed of the virtual racer model 72, 73 and the calculated position and speed of the controllable virtual racer 80.

Accordingly, generating the visual representation comprises generating visual representation comprising visual representation of the virtual racer model 72, 73 in the virtual racetrack 71 based on the calculated position and speed of the virtual racer model 72, 73. Accordingly, the visual representation is configured to present the virtual racer model 72, 73 in the virtual racetrack 71 with speed and position corresponding the real-world racer 11, 12 in the real-world racetrack 10 with real-world speed and position.

Further, generating the visual representation comprises generating visual representation comprising visual representation of the controllable virtual racer 80 in the virtual racetrack 71 based on the calculated position and speed of the controllable virtual racer 80. Accordingly, the visual representation is configured to present the controllable virtual racer 80 in the virtual racetrack 71 with speed and position calculated based on the control data.

Accordingly, the visual representation is configured to simultaneously represent the virtual racer model 72, 73 and the controllable virtual racer 80 in the virtual racetrack 71.

Th method comprises continuously generating visual representation of the virtual environment 70 representing simultaneously instantaneous position and speed of the virtual racer model 72, 73 and the controllable virtual racer 80 in the virtual racetrack 71 based on the calculated position and speed of the virtual racer model 72, 73 and the calculated position and speed of the controllable virtual racer 80. The visual representation is continuously updated based continuously calculated instantaneous position and speed of the virtual racer model 72, 73 and the calculated position and speed of the controllable virtual racer 80.

The method further comprises receiving, in the computer system 50, 50′, environmental measurement data from one or more environmental sensors 90, 91 provided in connection with the real-world racetrack 10, modifying the control data associated with the controllable virtual racer 80 based on the environmental measurement data and generating modified control data based on modifying the control data, and calculating position and speed of the controllable virtual racer 80 in the virtual racetrack 71 based on the modified control data associated with the controllable virtual racer 80.

Accordingly, the response to user input via the user device 60, 65 or input device 64 of the user device 60, 65 is modified based on the environmental measurement data from one or more environmental sensors 90, 91. Therefore, at least the position and speed or position, speed and orientation of the virtual racer in the virtual racetrack is calculated based on the control data and the environmental measurement data, meaning the modified control data.

Thus, humidity, water, temperature, wind or other environmental factors in the real-world racetrack are configured to affect the control of the virtual racer. Thus, the control of the virtual racer becomes more authentic.

In some embodiments, the one or more environmental sensors 90, 91 comprise the racetrack sensors configured to generate or measure environmental measurement data of the real-world racetrack 10.

The method comprises calculating racetrack data by utilizing the environmental measurement data of the racetrack sensors 90, 91, and determining virtual racetrack characteristics of the virtual racetrack 71 based on the calculated racetrack data. The method further comprises modifying the control data associated with the controllable virtual racer 80 based on the determined virtual racetrack characteristics and generating the modified control data based on the determined virtual racetrack characteristics.

The racetrack sensors 90, 91 may comprises humidity sensor, and/or temperature sensor, and/or surface sensor configured to measure humidity and/or temperature and/or surface of the racetrack.

The surface sensor may be configured to detect water and/or oil and/or objects on the real-world racetrack.

Accordingly, the control data is modified based on measured temperature, humidity and/or surface of the real-world racetrack.

Humidity, temperature and surface of the racetrack have significant effect on traction, grip and behaviour of the racer on the racetrack.

In some embodiments, the environmental sensors 90, 91, or racetrack sensors, comprise at least temperature sensor(s) configured to detect and/or measure temperature of the real-world racetrack 10.

In some embodiments, the one or more environmental sensors 90, 91 comprise the weather sensors configured to generate or measure environmental measurement data from the real-world racetrack 10. The weather sensors may be provided in addition to the racetrack sensors or instead of the racetrack sensors.

The method comprises calculating racetrack data by utilizing the environmental measurement data of the weather sensors 90, 91, and determining virtual environmental characteristics of the virtual racetrack 71 based on the calculated racetrack data. The method further comprises modifying the control data associated with the controllable virtual racer 80 based on the determined virtual environmental characteristics and generating the modified control data based on the determined virtual environmental characteristics or based on the determined virtual environmental characteristics and the determined virtual racetrack characteristics.

The weather sensors 90, 91 may comprises humidity sensor, and/or temperature sensor, and/or wind sensor configured to measure humidity and/or temperature and/or wind in the racetrack.

Accordingly, the control data is modified based on measured temperature, humidity and/or wind of the real-world racetrack.

Humidity, temperature and wind of the racetrack have significant effect on traction, grip and behaviour of the racer on the racetrack. The method system of the present invention is configured to carry out the method of the present invention.

The invention has been described above with reference to the examples shown in the figures. However, the invention is in no way restricted to the above examples but may vary within the scope of the claims.

1. A method for mixed-reality race game, the method being carried out by a computer system in a network having at least one user device, characterized in that the method is carried out by the computer system and comprises:
providing a virtual racing environment comprising a virtual racetrack, the virtual racetrack being a virtual representation of a real-world racetrack,
providing a virtual racer model representing a real-world racer,
providing a controllable virtual racer,
receiving, in the computer system, telemetry data from the real-world racer moving on the real-world racetrack, the telemetry data comprising at least position data and motion data of the real-world racer, and associating telemetry data of the real-world racer with the virtual racer model,
receiving, in the computer system, control data from a user device, and associating the control data with the controllable virtual racer,
calculating position and speed of the virtual racer model in the virtual racetrack based on the telemetry data associated with the virtual racer model,
calculating position and speed of the controllable virtual racer in the virtual racetrack based on the control data associated with the controllable virtual racer, and
generating a visual representation of the mixed-reality race game comprising the virtual racing environment representing the virtual racer model together with the controllable virtual racer in the virtual racetrack based on the calculated position and speed of the virtual racer model and the calculated position and speed of the controllable virtual racer, characterized in that the method further comprises:
receiving, in the computer system, environmental measurement data from one or more environmental sensors provided in connection with the real-world racetrack, and
modifying the control data associated with the controllable virtual racer based on the environmental measurement data and generating modified control data based on modifying the control data, and
calculating an update to the position and the speed of the controllable virtual racer in the virtual racetrack based on the modified control data associated with the controllable virtual racer.

2. A method according to claim 1, further comprising:
calculating racetrack data by utilizing the environmental measurement data, and determining virtual racetrack characteristics of the virtual racetrack based on the calculated racetrack data, and
modifying the control data associated with the controllable virtual racer based on the determined virtual racetrack characteristics and generating the modified control data based on the determined virtual racetrack characteristics.

3. A method according to claim 1, further comprising:
calculating racetrack data by utilizing the environmental measurement data, and determining virtual racing environment characteristics of the virtual racing environment based on the calculated racetrack data, and
modifying the control data associated with the controllable virtual racer based on the determined virtual racing environment characteristics and generating the modified control data based on the determined virtual racing environment characteristics or based on the determined virtual racetrack characteristics and the determined virtual racing environment characteristics.

4. A method according to claim 1, further comprising:
generating modified motion control data,
wherein the control data comprises at least motion control data, the motion control data defining motion of the controllable virtual racer in the virtual racing environment, and
calculating position and speed or position, speed and orientation of the controllable virtual racer in the virtual racetrack based on the modified motion control data.

5. A method according to claim 1, wherein the control data comprises orientation control data, the orientation control data defining orientation of the controllable virtual racer in the virtual racing environment, and
further comprising:
generating modified orientation control data, and
calculating orientation of the controllable virtual racer in the virtual racetrack based on the modified orientation control data.

6. A method according to claim 1, further comprising:
receiving, in the computer system, the environmental measurement data as real-time environmental measurement data,
receiving, in the computer system, the control data as real-time control data, generating continuously real-time modified control data based on modifying the real-time control data, and
calculating continuously real-time position and speed of the controllable virtual racer in the virtual racetrack based on the real-time modified control data; or
generating continuously instantaneous modified control data based on modifying the received control data, and
calculating continuously instantaneous position and speed of the controllable virtual racer in the virtual racetrack based on the instantaneous modified control data.

7. A method according to claim 1, further comprising:
generating the visual representation of the virtual racing environment by utilizing the environmental measurement data; or
generating the visual representation of the virtual racing environment by utilizing the calculated racetrack data, the virtual racing environment comprising a visual representation of virtual racing environment characteristics of the virtual racing environment, the visual representation of the virtual racetrack characteristics of the virtual racetrack, or a visual representation of the virtual racing environment characteristics of the virtual racing environment and a visual representation of the virtual racetrack characteristics of the virtual racetrack.

8. A method according to claim 1, wherein:
providing a 2-dimensional virtual racing environment comprising the virtual racetrack; or
providing a 3-dimensional virtual racing environment comprising the virtual racetrack.

9. A method according to claim 1, wherein:
the virtual racetrack comprises positioning data configured to define positions in the virtual racetrack, the positioning data comprising real-world coordinates configured to associate corresponding positions in the real-world racetrack with the defined positions in the virtual racetrack; or
the virtual racetrack comprises positioning data defining positions in the virtual racetrack, the positioning data comprises virtual coordinates configured to represent positions in the virtual racetrack and real-world coordinates configured to represent positions in the real-world racetrack, the positioning data being configured to associate virtual coordinates with corresponding real-world racetrack, or
the virtual racetrack comprises positioning data comprising spatial mapping data configured to define positions of the virtual racetrack and corresponding real-world positions in the real-world racetrack.

10. A method according to claim 1, wherein:
the virtual racer model comprises a two-dimensional racer model representing the real-world racer; or
the virtual racer model comprises a three-dimensional racer model representing the real-world racer; or
the virtual racer model comprises a three-dimensional racer model configured to correspond the real-world racer.

11. A method according to claim 1, wherein:
the controllable virtual racer is provided as a two-dimensional controllable racer model; or
the controllable virtual racer is provided as a three-dimensional controllable racer model.

12. A method according to claim 1, further comprising associating the received telemetry data with the virtual racer model.

13. A method according to claim 1, wherein the real-world racer comprises one or more sensors configured to detect parameters of the real-world racer and to generate the telemetry data based on the detected parameters, the detected parameters comprise at least position and motion of the real-world racer detected by the one or more sensors.

14. A method according to claim 1, further comprising:
receiving, in the computer system, the telemetry data as continuous telemetry data from the real-world racer; or
receiving, in the computer system, the telemetry data as streaming telemetry data from the real-world racer; or
receiving, in the computer system, the telemetry data as continuous streaming telemetry data from the real-world racer.

15. A method according to claim 1, further comprising:
receiving, in the computer system, the control data as continuous control data from the user device; or
receiving, in the computer system, the control data as a response to user input from the user device; or
wherein:
the user device comprises one or more input devices configured to generate control data as a response to user input, and receiving, in the computer system, the control data from the user device; or
the user device comprises one or more input devices configured to generate control data as a response to user input, and receiving, in the computer system, the control data as continuous control data from the user device.

16. A method according to claim 1, further comprising:
receiving, in the computer system, the telemetry data as real-time telemetry data and calculating continuously real-time position and speed of the virtual racer model in the virtual racetrack based on the real-time telemetry data; or
storing, in the computer system, the received telemetry data as stored telemetry data, and calculating continuously instantaneous position and speed of the virtual racer model in the virtual racetrack based on the stored telemetry data.

17. A method according to claim 1, further comprising:
continuously generating visual representation of the virtual environment representing simultaneously instantaneous position and speed of the virtual racer model and the controllable virtual racer in the virtual racetrack based on the calculated position and speed of the virtual racer model and the calculated position and speed of the controllable virtual racer; or
generating a real-time visual representation of the virtual environment representing simultaneously real-time position and speed of the virtual racer model and the controllable virtual racer in the virtual racetrack based on the calculated position and speed of the virtual racer model and the calculated position and speed of the controllable virtual racer.

18. A method according to claim 17, further comprising:
receiving the generated visual representation in the user device, and presenting the generated visual representation in a display device provided in connection with the user device; or
receiving the generated visual representation in the user device as streaming visual representation data, and presenting the generated visual representation data continuously in a display device provided in connection with the user device; or
receiving the generated real-time visual representation in the user device as real-time visual representation data, and presenting the generated real-time visual representation data continuously in a display device provided in connection with the user device.

19. A method according to claim 1, further comprising:
time synchronizing the position and speed of the virtual racer model and the position and speed of the controllable virtual racer in the visual representation; or
time synchronizing the position and speed of the virtual racer model and the position and speed of the controllable virtual racer before generating the visual representation.

20. A method according to claim 1, further comprising:
providing two or more virtual racer models representing two or more real-world racers, respectively,
receiving, in the computer system, telemetry data from two or more real-world racers moving on the real-world racetrack, associating the telemetry data received from each of the real-world racers with one of the two or more virtual racer models, the telemetry data comprising at least position data and motion data of the real-world racer,
calculating position and speed of each of the virtual racer models in the virtual racetrack based on the telemetry data associated with the virtual racer model, and
generating the visual representation of the virtual environment representing the two or more virtual racer models together the controllable virtual racer in the virtual racetrack based on the calculated position and speed of each of the two or more virtual racer models and the calculated position and speed of the controllable virtual racer.

21. A system for mixed-reality race game, the system comprising a computer system comprising instructions which when executed on at least one processor of the computer system cause the computer system to perform mixed-reality race game in a network, and a user device connectable to the computer system in the network, the computer system is configured to:
provide a virtual racing environment comprising a virtual racetrack, the virtual racetrack being a virtual representation of a real-world racetrack,
provide a virtual racer model representing a real-world racer,
provide a controllable virtual racer,
receive, in the computer system, telemetry data from the real-world racer moving on the real-world racetrack, the telemetry data comprising at least position data and motion data of the real-world racer, and associating telemetry data of the real-world racer with the virtual racer model,
receive, in the computer system, control data from the user device, and associating the control data with the controllable virtual racer
calculate position and speed of the virtual racer model in the virtual racetrack based on the telemetry data associated with the virtual racer model,
calculate position and speed of the controllable virtual racer in the virtual racetrack based on the control data associated with the controllable virtual racer, and
generate a visual representation of the mixed-reality race game comprising the virtual environment representing the virtual racer model together with the controllable virtual racer in the virtual racetrack based on the calculated position and speed of the virtual racer model and the calculated position and speed of the controllable virtual racer, wherein the computer system is further configured to:
receive environmental measurement data from one or more environmental sensors provided in connection with the real-world racetrack, and
modify the control data associated with the controllable virtual racer based on the environmental measurement data and generating modified control data based on modifying the control data, and
calculate an updated to the position and the speed of the controllable virtual racer in the virtual racetrack based on the modified control data associated with the controllable virtual racer.

22. A system according to claim 21, wherein the system comprises one or more real-world racers comprising one or more sensors configured to detect parameters of the real-world racer and to generate the telemetry data based on the detected parameters, the detected parameters comprise at least position and motion of the real-world racer model detected by the one or more sensors.

23. A system according to claim 21, wherein the user device comprises one or more input devices configured to generate control data as a response to user input.

24. A system according to claim 21, wherein the system comprises:
one or more environmental sensors provided in connection with the real-world racetrack and configured to the generate the environmental measurement data, wherein the computer system is configured to receive the environmental measurement data from one or more environmental sensors; or
one or more environmental sensors provided in connection with the real-world racetrack and configured to the generate the environmental measurement data, and wherein the computer system is configured to receive the environmental measurement data from one or more environmental sensors, calculate racetrack data by utilizing the environmental measurement data, and to determine virtual racing environment characteristics of the virtual racing environment, virtual racetrack characteristics of the virtual racetrack or virtual racing environment characteristics of the virtual racing environment and virtual racetrack characteristics of the virtual racetrack based on the calculated racetrack data.

25. A system according to claim 21, wherein:
the system comprises a display device configured to present the visual representation of the mixed-reality race game; or
the user device comprises a display device configured to present the visual representation of the mixed-reality race game.

26. A computer program product, wherein the computer program product comprises instructions, which, when executed by a computing system, cause the computing system to perform a method for a mixed-reality game comprising steps to:
provide a virtual racing environment comprising a virtual racetrack, the virtual racetrack being a virtual representation of a real-world racetrack,
provide a virtual racer model representing a real-world racer,
provide a controllable virtual racer,
receive, in the computer system, telemetry data from the real-world racer moving on the real-world racetrack, the telemetry data comprising at least position data and motion data of the real-world racer, and associating telemetry data of the real-world racer with the virtual racer model,
receive, in the computer system, control data from a user device, and associating the control data with the controllable virtual racer
calculate position and speed of the virtual racer model in the virtual racetrack based on the telemetry data associated with the virtual racer model,
calculate position and speed of the controllable virtual racer in the virtual racetrack based on the control data associated with the controllable virtual racer, and
generate a visual representation of the mixed-reality race game comprising the virtual environment representing the virtual racer model together with the controllable virtual racer in the virtual racetrack based on the calculated position and speed of the virtual racer model and the calculated position and speed of the controllable virtual racer, wherein the computer system is further configured to:
receive environmental measurement data from one or more environmental sensors provided in connection with the real-world racetrack, and
modify the control data associated with the controllable virtual racer based on the environmental measurement data and generating modified control data based on modifying the control data, and
calculate at least one update to the position and the speed of the controllable virtual racer in the virtual racetrack based on the modified control data associated with the controllable virtual racer.
